(19) United States
(12) Patent Application Publication
(10) Pub. No.: US 2002/0103867 A1
(43) Pub. Date: Aug. 1, 2002

(54) Method and system for matching and exchanging unsorted messages via a communications network

(76) Inventor: Theo Schilter, Zurich (CH)

Correspondence Address: Richard Voellmy, Department of Biochemistry & Molecular Biology, Univ of Miami School of Medicine, 1011 N.W. 15th Street, Miami, FL, 33136, US

(21) Appl. No.: 09/772,164

(22) Filed: Jan. 29, 2001

(51) Int. Cl. G06F 15/16

(52) U.S. Cl. 709/206; 707/3

(57) ABSTRACT

The invention relates to a system and method to publish, match and access messages without any predefined format. It provides methods, software and apparati for receiving and matching messages sent by different users and forwarding the matching results to concerned users. The system receives a message (eg. by email, SMS, voice mail, fax, telephone), converts it into text data when needed, identifies keywords, stores it, looks for previously stored messages with corresponding keywords and forwards the matching messages to respective senders. The system provides a method to publish and search other published messages by one action. It is useful for matching buyers' and sellers' needs.

### FIELD OF THE INVENTION

The invention relates to a system and method to publish, match and access user messages without any predefined format via a communications network.

### BACKGROUND OF THE INVENTION

The Internet comprises a vast number of computers and computer networks that are interconnected through communication links. The interconnected computers exchange information using various services, such as electronic mail (email), Gopher, and the World Wide Web (“WWW”). The WWW service allows a server computer system (i.e., Web server or Web site) to send graphical Web pages of information to a remote client computer system. The remote client computer system can then display the Web pages. Each resource (e.g., computer or Web page) of the WWW is uniquely identifiable by a Uniform Resource Locator (“URL”). To view a specific Web page, a client computer system specifies the URL for that Web page in a request (e.g., a HyperText Transfer Protocol (“HTTP”) request). The request is forwarded to the Web server that supports that Web page. When that Web server receives the request, it sends that Web page to the client computer system. When the client computer system receives that Web page, it typically displays the Web page using a browser. A browser is a special-purpose application program that effects the requesting of Web pages and the displaying of Web pages.

The Difference Between Information and Messages

Within the broad variety of what is called “information” there is a special category: information that is of use only in combination with sender's address. Such information is necessarily bound to its sender and is referred to herein as a “message”. E.g. the information “There will be snow tomorrow.” is of use without knowing the sender/author of this information. But the information “I want to buy a table.” is if use only if you know sender's address. The WWW typically is dedicated to general information rather than information that is necessarily bound to its sender such as in messages. Email, on the other hand, is a medium dedicated to messages. Emails consist of a sender's address and content. Other media dedicated to messages are voice mail, SMS, fax, letter and telephone.

Different Media and their Authorization to Read and Write

Every means to exchange information (media) has its specific audience of authorization for read (see) and for write (create and change). E.g. everybody is authorized to read pages on the WWW but few are authorized to write these pages. The WWW thus is a medium typically written by few people for all people.

At the same time, the email medium allows emails to be written by all people but these sent emails are read only by few people. Authorization to read is defined by the addressees, which must be listed individually or otherwise specifically defined by a sender. Users who are not listed as addressees on an email normally cannot read the email.

Currently there are few ways for the public to write messages that can be read by the public. While Bulletin Board systems allow this, they generally lack convenience. To date, the most prominent Bulletin Board system are 1) the usenet and 2) discussion forums on websites. The usenet allows the public to read and send messages. It is structured in discussion groups. Every discussion group is dedicated to a special theme. Users have to search for discussion groups of their interest and subscribe to it. A subscriber to a discussion group receives all messages sent to the discussion group. No selection nor matching process is made. Messages of interest in other discussion groups are missed. Commercial messages are unwanted in the usenet. Discussion forums on websites provide similar features to users like the usenet. They are usually dedicated to a theme and without selection, too. Additionally they are bound to websites and users have to search for them. Besides they rarely notify users on new messages of interest.

On the internet there is currently no way to publish messages authored by the broad public and directed to the broad public which provides all of the three following features: 1) publishing a message by a medium dedicated to messages (email, voice mail, SMS, fax, telephone); 2) selection of other messages that match with the message; 3) sending only the matching messages to the sender.

### SUMMARY OF THE INVENTION

The present invention combines the WWW's broad accessibility to read with the broad accessibility to write of message-dedicated media such as email. It provides methods, software and apparati for receiving and matching messages sent by different users and forwarding the matching results to concerned users.

A user message may contain a request for a product, service or information. This message is matched with messages of providers of said product, service or information. Then a list of the matching messages is sent to the respective users. Thus requesters and providers are matched.

As referred to herein, a user can comprise a requester of a product, service or information as well as a provider of a product, service or information. In the preferred embodiments, users, including both requesters and providers can use the present method, software and apparati in the same manner.

In one aspect, the invention provides a method for a user to place a message and receive information about messages that contain related information. In another aspect, the invention provides software for receiving and matching users messages and furthermore for informing users of matched messages. In yet another aspect, the invention encompasses a method for processing user messages. As further discussed herein, related messages can comprise for example messages related by similar subject matter, by keywords, by a customer-vendor relationship, by a question-answer relationship, etc.

According to the present invention, the system of the invention receives a message from a user by any suitable data transmission means, for example online access, electronic mail (email), short message system (SMS) or speech. The subject matter of the user message is preferably provided to the system essentially without any predetermined fields or classification, such as in freetext or free speech form. Each message is associated with a user address. The system of the invention stores the user message in a database. The system then identifies user messages which ‘match’ one another based on their subject matter. This matching step preferably involves identifying keywords in the user message and uses said keywords to search the content of other user messages in the database, or using keywords identified in the user messages stored in the database to search the new user message. The system then notifies users of the system whose messages have matched one another. This notification step may comprise notifying the user who transmitted the new message as well as notifying a user whose message was previously entered in the database.

In one aspect, the invention thus comprises a method of using a computer system to process user messages, comprising receiving by said computer system from a first user a first user message including a first user contact address and a first user message body, wherein said first user message body is provided essentially as text or speech without any predefined structure; storing said first user message and first user address in a user message database comprising a plurality of previously stored user messages; querying said message database for previously stored user messages related in subject matter to said first user message; and notifying said first user of a previously stored message identified in said querying step which relates to said first user message.

In another embodiment, the invention comprises a system for processing user messages, comprising a memory device storing a program; a processor in communication with said memory; said processor operative with said program to: (a) receive by said computer from a first user a first user message and a first user contact address, wherein said first user message is provided essentially as text or speech without any predefined structure; (b) store said first user message and first user address in a message database comprising a plurality of previously stored messages; (c) query said message database for previously stored messages related in subject matter to said first user message; and (d) notify said first user of a previously stored message identified in said query step which relates to said first user message.

In a further embodiment, the invention comprises an article of manufacturing comprising a computer readable medium comprising instructions for: (a) receiving by said computer from a first user a first user message and a first user contact address, wherein said first user message is provided essentially as text or speech without any predefined structure; (b) storing said first user message and first user address in a message database comprising a plurality of previously stored messages; (c) querying said message database for previously stored messages related in subject matter to said first user message; and (d) notifying said first user of a previously stored message identified in said querying step which relates to said first user message.

In another embodiment, the invention relates to method of using a computer system to send and receive user messages, comprising: sending to a computer system a first user message including a first user contact address and a first user message body, wherein (a) said first user message body is provided essentially as text or speech without any predefined structure, wherein said first user message and first user address is stored in a user message database comprising a plurality of previously stored user messages; (b) said message database is queried for previously stored user messages related in subject matter to said first user message; and receiving notification of a previously stored message identified in said querying step which relates to said first user message.

Furthermore, in any of the above mentioned embodiments, the message database further comprises a plurality of previously stored user contact addresses corresponding to said plurality of previously stored messages. Optionally, in any of the above mentioned embodiments, if a previously stored message relating to the first user message is identified after said querying step, a user from which said previously stored message was received is notified of the first user message. In preferred embodiments, user messages are received by e-mail, SMS or speech. The methods of using a computer system to process user messages, system for processing user messages, article of manufacturing comprising a computer readable medium comprising instructions and methods of using a computer system to send and receive user messages may comprise the storing of (e.g. in a database), processing of, or notifying of at least 1, 2, 10, 100, 1000, 100000 or 1000000 user messages. Preferably, the step of querying said message database comprises identifying keywords in said first user message and querying said message database for previously stored messages containing said keywords, or words related thereto.

### BRIEF DESCRIPTION OF THE DRAWINGS

FIG. 1 is a flow diagram of a routine which processes a message received from a user.

FIG. 2 is a flow diagram of a routine which is performed by a user transmitting a message to the pinboard management system of the invention.

FIG. 3 is a flow diagram of a routine showing the steps performed by the pinboard management system and the user systems during the processing of a user message.

FIG. 4 is a flow diagram of an exemplary routine which processes a message from a user received in a non-text format.

FIG. 5 shows the parts of a pinboard management system (PMS) in accordance with one of the embodiments of the invention.

### DETAILED DESCRIPTION OF THE INVENTION

Definitions

1. Database

A database includes indexed and freeform tables for storing data. Within each table are a series of fields that store data strings, such as names, addresses, chemical names, and the like. However, it should be realized that several types of databases are available. For example, a database might only include a list of data strings arranged in a column. Other databases might be relational databases wherein several two dimensional tables are linked through common fields. Embodiments of the invention are not limited to any particular type of database.

2. Input Devices

An input device can be, for example, a keyboard, rollerball, mouse, voice recognition system, automated script from another computer that generates a file, or other device capable of transmitting information from a user to a computer. The input device can also be a touch screen associated with the display, in which case the user responds to prompts on the display by touching the screen. The user may enter textual information through the input device such as the keyboard or the touch-screen.

3. Instructions

Instructions refer to computer-implemented steps for processing information in the system. Instructions can be implemented in software, firmware or hardware and include any type of programmed step undertaken by components and modules of the system.

4. LAN

One example of a Local Area Network may be a corporate computing network, including access to the Internet, to which computers and computing devices comprising the system are connected. In one embodiment, the LAN conforms to the Transmission Control Protocol/Internet Protocol (TCP/IP) industry standard. In alternative embodiments, the LAN may conform to other network standards, including, but not limited to, the International Standards Organization's Open Systems Interconnection, IBM's SNA, Novell's Netware, and Banyan VINES.

5. Media

Media refers to the system and format of transmission of the messages to and from the PMS.

6. Microprocessor

A microprocessor as used herein may be any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. The microprocessor typically has conventional address lines, conventional data lines, and one or more conventional control lines.

7. Modules

The system can be comprised of various modules as discussed below. As can be appreciated by one of ordinary skill in the art, each of the modules comprises various sub-routines, instructions, commands, procedures, definitional statements and macros. Each of the modules are typically separately compiled and linked into a single executable program. Therefore, the following description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

8. Networks

The system may include any type of electronically connected group of computers including, for instance, the following networks: Internet, Intranet, Local Area Networks (LAN) or Wide Area Networks (WAN). In addition, the connectivity to the network may be, for example, remote modem, Ethernet (IEEE 802.3), Token Ring (IEEE 802.5), Fiber Distributed Datalink Interface (FDDI) or Asynchronous Transfer Mode (ATM). Note that computing devices may be desktop, server, portable, hand-held, set-top, or any other desired type of configuration. As used herein, an Internet includes network variations such as public internet, a private internet, a secure internet, a private network, a public network, a value-added network, an intranet, and the like.

9. Operating Systems

The system may be used in connection with various operating systems such as: UNIX, Disk Operating System (DOS), OS/2, Windows 3.X, Windows 95, Windows 98, Windows 2000 and Windows NT.

10. Programming Languages

The various software aspects of the system may be written in any programming language such as C, C++, BASIC, Pascal, Perl, Java, and FORTRAN and run under a well-known operating system. C, C++, BASIC, Pascal, Java, and FORTRAN are industry standard programming languages for which many commercial compilers can be used to create executable code.

11. Pinboard Management System (PMS)

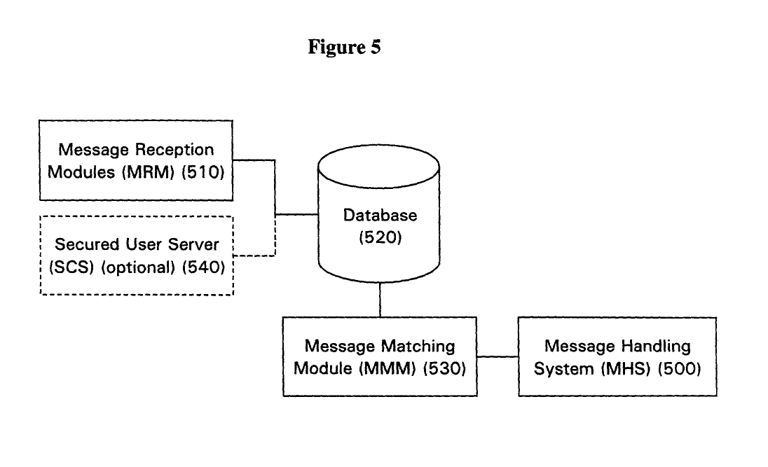

The PMS is the entity of the present invention. It comprises a database, a message handling system (MHS), one or more message reception modules (MRM), a message matching module (MMM) and optionally one or more secured user servers (SCS). See FIG. 5

12. User Contact Address (UCA)

The UCA typically is the message sender's unique address. This address can differ depending on the medium a user chooses to send the message. If the user sends the message by email or voice mail, the UCA is the email address the message is sent from. If the user transmits his message by telephone, fax or SMS the UCA is the telephone or fax number the message is sent from.

13. Message Reception Module (MRM)

The MRM is a data conversion system that manages the conversion of incoming messages into a format that can be processed by the MMM.

14. Message Matching Module (MMM)

The MMM identifies keywords in a message to be searched against a database and uses said keywords as queries to identify other database records containing said keywords or keywords that comply with rules defined in the MMM. A matching rule can be: <“buy” matches with “sell”>.

15. Secured User Server (SCS)

The SCS allows users to place and update a large number of messages.

16. Message Handling System (MHS)

The MHS informs users on results of message matching.

17. Index

An index is a systematic guide designed to indicate topics or features of documents in order to facilitate retrieval of documents or parts of documents. Indexes include the following major components: (1) terms representing the topics or features of documentary units; (2) a syntax for combining terms into headings (in displayed indexes) or search statements (in non-displayed indexes) in order to represent compound or complex topics, features, and/or queries; (3) links or cross-references among synonymous, equivalent, and related terms; (4) a procedure for linking headings (in displayed indexes) or search statements (in non-displayed indexes) with particular documentary units; and (5) a systematic ordering of headings (in displayed indexes) or a search procedure (in non-displayed indexes).

Indexing is the operation of creating an index for information retrieval. Indexing involves the selection and assignment of terms to, or the extraction of terms from, a documentary unit in order to indicate topics, features, or possible uses of the unit; the combination of terms into headings or the tagging of terms for subsequent combination (in displayed indexes); the linking of synonymous, equivalent and related terms or headings; the linking of terms or headings to documentary units; and the arrangement of headings in a systematic order (in displayed indexes).

A locator is the part of an entry in a displayed index that indicates the location of the documentary unit to which the entry refers. Locators range from brief notations, such as page numbers, to full bibliographic citations.

Method and System for Matching and Exchanging Unsorted Messages Via a Communications Network

Embodiments of the invention relate to electronic systems, software and methods for matching messages received from one or more users. For example, the messages may comprise but are not limited to requests and offers. The present invention provides methods, software and apparati for receiving and matching messages sent by different users and forwarding the matching results to concerned users.

A message from a user may be in virtually any form and may contain any information type and content. In particularly preferred embodiments, a user is an individual or company seeking a particular product, service or information, or an individual or company providing a product, service or information. The system of the invention allows users with messages related in subject matter to be informed of each others' related message, or clients and providers of a particular service to be informed of each others' message.

The message is provided to the pinboard management system (PMS) with minimal or no constraint as to message format or fields of subject matter. A message always contains user contact address (UCA). The message is preferably provided in sentence or keyword format, essentially in freetext form. In other preferred embodiments, the message is provided in free speech. Thus, the system of the invention allows a plurality of messages having unrelated subject matter to be received, stored in one or more databases, and queried against a database of messages. Messages received from users can optionally be pre-sorted.

The User and the User Message

A user message may contain any desired information. A message always contains user contact address (UCA). As used herein, a “message” refers to information, including a UCA, transmitted to the system of the invention.

In exemplary embodiments, a user is a vendor whose message contains a description of a product or service available for sale. A single product description can be provided in a posting, or the user can post information relating to multiple products—such as an entire catalog of products.

A user may send a message describing a product or service which said user is seeking to acquire. The user message may seek information about a vendor or the price or specifications of said product or service. In other examples, the user message may seek to acquire a product directly, wherein the product (e.g. software, an electronic document) is provided in a reply to his message.

As explained further herein, a user message will typically be in text format. As such, an exemplary user message may describe a commercially available product by generic name, trade name, manufacturer, vendor, owner, colloquial name, in various languages, or by a description of its features.

In other embodiments, a user posts the information or product of interest directly to the system of the invention. In this embodiment, a user message comprises an attached electronic file which is not to be included as searchable text during the database querying process. An electronic file typically comprises a product such as software, an information product (e.g. lists or tables on a topic of interest), sound (eg. wav or MP3) or graphic files.

In other embodiments, a user may seek user contact address for another user who has provided a related message. For example, the user may seek and be provided with (by the system) an internet address of a matching message, such that the user may contact the matching user.

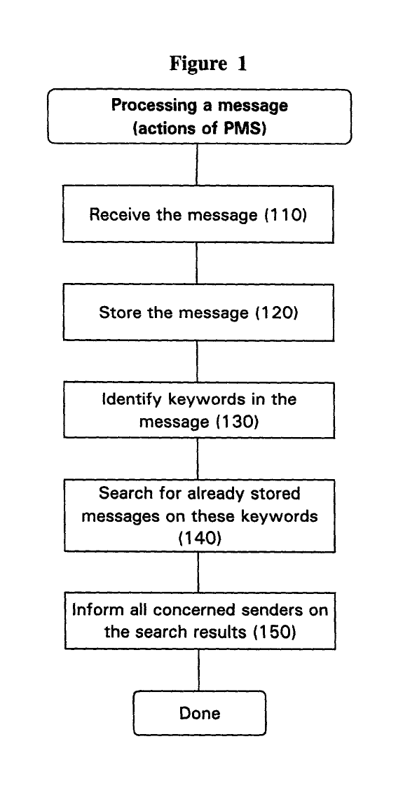

FIG. 1 shows a pinboard management system (PMS) for receiving messages from users, storing messages and user information, matching messages from different users and informing users of matching results. As used herein, a ‘message’ includes but is not limited to requests and offers. As shown in the example in FIG. 1, when processing a message, the PMS system of the invention receives a message from a user (110) at a first process step. The system moves to a second process step where the user message is stored and indexed (120), typically in a database. The system moves to a third process step (130) where keywords are identified in the user message. The system then moves to a fourth process step (140) where said keywords are used to search stored messages to identify related messages, and then to a fifth process step (150) where the user is informed of the results of the searching process (140).

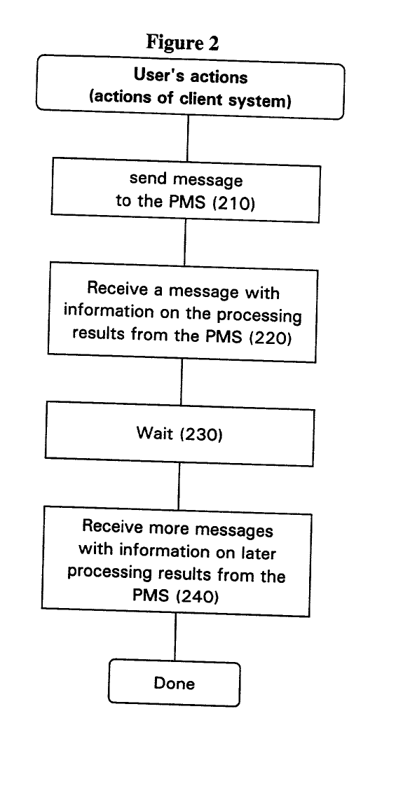

FIG. 2 shows an example of the actions carried out by a user of the PMS. In a first process step (210), a user sends a message to the PMS. In a second process step (220), the user receives a message providing information on the processing results from the PMS, including information about matches with other messages stored in the PMS and identified by process (140) in FIG. 1. Optionally, the user moves to a process step (230) where the user waits to receive further messages from the PMS providing information on the processing results (e.g. from new messages matching to the user's message). Optionally, the user moves to a process step (240) where one or ore further messages providing information about the processing results from the PMS are received.

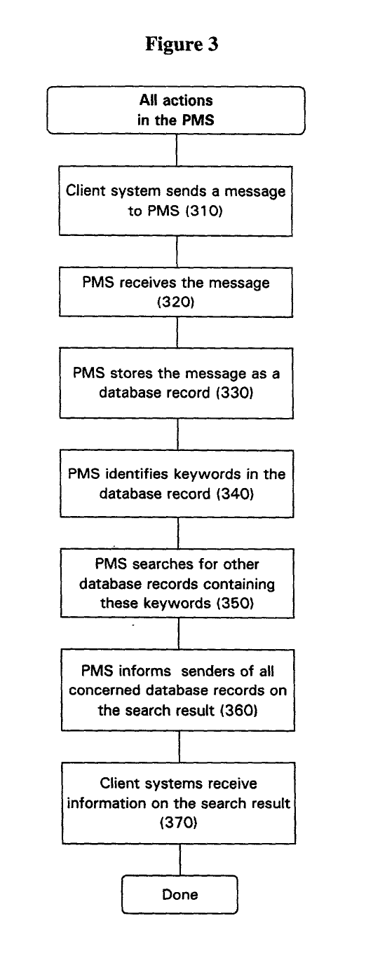

FIG. 3 shows an example of the combined process steps carried out by the PMS system and a user of the PMS system. In a first process step (310), the user system sends a message which is received by the PMS in process step (320). The PMS stores the received user message as a database record in process step (330). The PMS moves to a fourth process step (340) where the PMS identifies keywords in the message or database record. The system then moves to a fifth process step (350) where the PMS searches stored messages to identify related messages or database records, and then to a sixth process step (360) where the PMS informs a user (or all users) of one or more, or of all the messages identified in step (350) as related to said user's message. In process step (370), a user then receives the message sent by the PMS in process step (360).

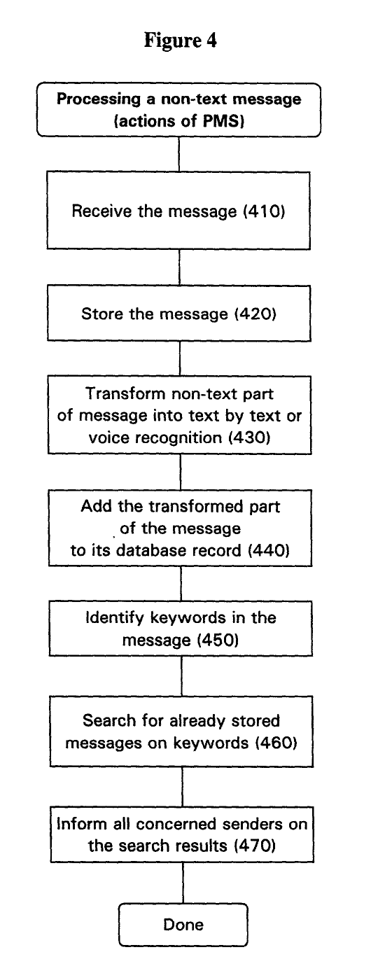

FIG. 4 shows process steps carried out in an example of the processing of a non-text message. The PMS system of the invention receives a non-text message such as a voice (e.g. telephone) message from a user (410) at a first process step. The system moves to a second process step where the user message is stored (420) in any format suitable for storing said message (e.g. any voice recording device). The system moves to a third process step (430) where the nontext portion of the message is transformed into text format by text or voice recognition module. The system moves to a fourth process step (440) where the transformed message portion is stored in a database. The system moves to a fifth process step (450) where keywords are identified in the user message. The system then moves to a sixth process step (460) where said keywords are used to search stored messages to identify related messages, and then to a seventh process step (470) where the user is informed of the results of the searching process (460).

As shown in FIG. 5, the PMS preferably includes a MHS (500). The MHS (500) manages the message matching process and directs the process of communicating with users.

Messages from users are received in essentially unstructured form with respect to subject matter content. In preferred examples, a SMS or email message is sent to the PMS by a user in letter (ie sentence or paragraph) format. User messages may be received without the necessity for input forms or predetermined terminology. User message can consist of only a text string and user contact address (UCA). Preferably it additionally will contain a subject-string which summarizes the content of the message. An example of such a message is an email consisting of UCA, subject-line and body. Another example is an SMS consisting of sender's phone number as UCA an text string. A third example is a phone call with the caller's phone number as UCA and the transmitted speech converted into a text string by a voice recognition system as body of the message. A fourth example is a fax with the sending fax's phone number as UCA and the facsimile converted into a text string by a text recognition system (OCR) as body of the message.

The PMS system is capable of processing a set of messages that relate to more than one different subject matter field or more than one different type (eg. request, offer).

Messages received in speech format may contain essentially free speech.

Depending on the system used, input formats or keypad choices (eg speech systems) may be combined with freetext or free speech systems.

Messages from users can be received by a wide range of data transmission means, data formats and input means, as discussed further below. Along with a message, a user also transmits user contact address (UCA). A UCA may be an email address, a telephone number, physical street address or a fax number, for example. The UCA can also be any other suitable user identifier, such as a user's name or a unique identifier generated by a communication device, as long as the identified is known to the user or his communication device, allowing his retrieval of his/her search results from a central messaging system.

The PMS directs the storage of the received message and the UCA as one or more database records in at least one database (520). This database (520) allows the received message to be available for searching against subsequently received messages.

In preferred embodiments, user messages are received through text based formats such as electronic mail (email), online access, online form and short message system (SMS) or speech formats. However, any other data format can be used, including facsimile, written messages, etc.

Depending on the data format used, the PMS may further comprise one or more message reception modules (MRM) (510) for managing the conversion of incoming messages into a format that can be processed by the MMM (530).

Depending on the data format, the PMS converts a non-text message's content into a text format. The non-text message may have been previously stored on a data storage medium or may be converted to text format actively during transmission from a user. Conversion to text format from speech can be carried out using electronic voice recognition. (eg. ViaVoice, IBM Corp., U.S.A). Conversion to electronic text format from facsimile or paper messages can be automatically scanned using electronic text recognition (OCR). The PMS system may be configured to accept messages in two or more types of data format, including any combination of the data formats described herein. Upon conversion, messages can be stored in one or more databases or directly processed by the message matching module (MMM) (530).

The PMS system comprises a message matching module (MMM) (530). The MHS (500) directs new messages to be searched against the one or more message databases using the MMM (530) to identify related messages. Related messages as used herein preferably refers to messages which are related in the sense that one addresses or satisfies a request of another message. Optionally, messages can be related simply by common subject matter. For example, a message offering a product or offering information about the vendor of a product would be related to a message seeking to acquire said product. An example of an MMM (530) is a module that allows freetext messages to be matched by (1) identifying keywords in a user message to be searched against a database and (2) uses said keywords as queries to identify other database records containing said keywords.

Optionally, the PMS may further include one or more secured users servers (SCS) (540). In such embodiments, a user, typically a vendor seeking to place a large number of messages, provides his/her messages on a server connected to the PMS. In one example, an SCS (540) contains a catalog of services or products stored in a database, which records are included by the PMS when matching new user messages against previously stored messages in a database. A vendor's SCS may also comprise a module allowing a matching subroutine to be performed to match a free-text based user message more precisely within the set of records from said vendor.

If a user message is found to match a message previously stored in a database, the user is notified of the match by a Message Handling System (MHS) (500). The UCA linked to a user message stored in a database is used to direct notification to said user. The user may be notified by any suitable means or data format. Any of the data formats for receipt of messages discussed herein may also be used for user notification, although the user need not necessarily be notified in the same data format used to submit his message to the PMS.

The user notification performed by the MHS (500) may comprise any desired information. In one aspect, the user is informed of the existence of a matching record in the database and the place where to see the matching messages. In another embodiment, the user is provided with the content of the message stored in the database that matched his/her message. In further embodiments, the user who sent the previously stored message in the database against which the newly received message was found to match is notified of the matching result.

Preferably, both the user providing the newly received message and the user whose message was previously stored in the database are notified of the matching process results. Optionally, a user may be asked or may indicate whether he wishes to be notified of matching process results. Thus, once a first user transmits a message to the PMS, the PMS may notify a first user of (1) database records matching his newly received message and/or (2) subsequent messages from a second or subsequent user which match the first user's message stored in a database.

The MMM (530) and MHM (500) systems and processes can be invoked as desired. For example, the MMM (530) system may conduct matches and/or the MHM (500) may send notifications each time a new message is received. In other embodiments, the MMM (530) and MHM (500) are invoked only according to specific rules, such as at desired time intervals.

Data Conversion System

Incoming messages are preferably stored as received. If it is necessary to change the data format of an incoming message in order to allow processing of the message by the message matching system (MMM) (530), messages may be processed by their respective MRM (510).

Message Matching System

Each time a new message is received by the PMS from a user, a matching process can be carried out to identify related messages (which can be referred to as records) in a database. This is done by a MMM. An MMM can have essentially any suitable mode of operation, as long as it serves to match user messages according to desired rules for message matching. Preferably, the text of the message is analyzed and keywords are identified by parsing the input text. This ‘keywording’ can be done in the same way as search engines analyze texts on the internet. Analyzing text and identifying keywords is a process well known to those of skill in the art. Commercially available software with this function include ‘flyswat’, ‘pingpong’, AQUAD, Code-A-Text, HyperRESEARCH, TATOE, TEXTPACK, TextSmart, WinMAXpro. The identified keywords are stored in a database with a locator (index) referring to the message.

The rules to match keywords are defined in the MMM. E.g. a matching rule can be: <“buy” matches with “sell”>.

Databases

The MRM producing the converted messages stores them in a database. Database records can include but are not limited to for example date and time of message transmission, method of data transmission, user contact address (UCA), subject and/or body of message, result of data conversions by the MRM of any part of a message, pointer to the message originally received, keywords identified in a message, pointers to binary attachments. Pointers to this message can be stored in the found keyword's records on the keyword list of the database.

The user message database maintains a plurality of records, each associated with a message. For each message, the database record contains keywords identified in the text of the message as received from the user by the PMS. Preferably, the user message database also includes a message identification number field.

While the preferred embodiment of the invention has been illustrated and described, it will be appreciated that various changes can be made therein by the one skilled in the art without departing from the spirit and scope of the invention.

### EXAMPLES

### Example 1

The PMS receives a message as an email. It identifies parts of the message like date and time, sender's address, subject-line and body-text. It opens a new database record and stores the identified parts of the message in the respective fields of the record. It identifies keywords in the message and stores the result of this analysis. Then it searches the database with the previously stored messages for messages with matching keywords. A list of found matching messages or with links to them is generated and sent to respective sender's addresses by email. (FIG. 1)

### Example 2

The PMS receives a voice mail consisting of sender's address and binary data containing recorded voice. The MRM of the PMS converts the recorded voice data into text. The PMS then identifies parts of the message like date and time, sender's phone number as his address and body-text. It opens a new database record and stores the identified parts of the message in the respective fields of the record. It identifies keywords in the text converted from the voice message and stores the result of this analysis. Then it searches the database with the previously stored messages for messages with matching keywords. A list of links to found matching messages is generated. While the calling user still is connected the MHS informs him on the matching result by means of an artificial voice. The user can hear the matching voice messages and respective phone numbers by selecting 1 . . . 9 on his telephone. (FIG. 4)

### Example 3

The PMS receives a fax containing plain text types. The PMS then identifies parts of the message like date and time, sender's fax number as his address. The MRM of the PMS converts the typed text into a text string. It opens a new database record and stores the identified parts of the message in the respective fields of the record. It identifies keywords in the text converted from the fax message and stores the result of this analysis. Then it searches the database with the previously stored messages for messages with matching keywords. A list of links to found matching messages is generated an sent to respective sender's addresses. (FIG. 4)

1. A method of using a computer system to process user messages including requests and offers, comprising:
receiving by said computer system from a first user a first user message including a first user contact address and a first user message body, wherein said first user message body is provided essentially as text or speech without any predefined structure;
storing said first user message and first user address in a user message database comprising a plurality of previously stored user messages;
querying said message database for previously stored user messages related in subject matter to said first user message; and
notifying said first user of a previously stored message identified in said querying step which relates to said first user message.

2. The method of claim 1, wherein said message database further comprises a plurality of previously stored user contact addresses corresponding to said plurality of previously stored messages.

3. The method of claim 2, wherein if a previously stored message relating to said first user message is identified after said querying, a user from which said previously stored message was received is notified of the first user message.

4. The method of claim 1, wherein said first user message is received by e-mail.

5. The method of claim 1, wherein said first user message is received by SMS.

6. The method of claim 1, wherein said first user message is received by speech.

7. The method of claim 1, wherein said step of querying said message database comprises identifying keywords in said first user message and querying said message database for previously stored messages containing said keywords, or words related thereto.

8. A system for processing user messages including requests and offers, comprising:
a memory device storing a program;
a processor in communication with said memory;
said processor operative with said program to:
receive by said computer from a first user a first user message and a first user contact address, wherein said first user message is provided essentially as text or speech without any predefined structure;
store said first user message and first user address in a message database comprising a plurality of previously stored messages;
query said message database for previously stored messages related in subject matter to said first user message; and
notify said first user of a previously stored message identified in said query step which relates to said first user message.

9. The system of claim 8, wherein said message database further comprises a plurality of previously stored user contact addresses corresponding to said plurality of previously stored messages.

10. The system of claim 9, wherein if a previously stored message relating to said first user message is identified after said querying, a user from which said previously stored message was received is notified of the first user message.

11. The system of claim 8, wherein said first user message is received by e-mail.

12. The method of claim 8, wherein said first user message is received by SMS.

13. The method of claim 8, wherein said first user message is received by speech.

14. The method of claim 8, wherein said step of querying said message database comprises identifying keywords in said first user message and querying said message database for previously stored messages containing said keywords, or words related thereto.

15. An article of manufacturing comprising:
a computer readable medium comprising instructions for:
receiving by said computer from a first user a first user message and a first user contact address, wherein said first user message is provided essentially as text or speech without any predefined structure;
storing said first user message and first user address in a message database comprising a plurality of previously stored messages;
querying said message database for previously stored messages related in subject matter to said first user message; and
notifying said first user of a previously stored message identified in said querying step which relates to said first user message.

16. The article of manufacturing of claim 15, wherein said message database further comprises a plurality of previously stored user contact addresses corresponding to said plurality of previously stored messages.

17. The article of manufacturing of claim 16, wherein if a previously stored message relating to said first user message is identified after said querying, a user from which said previously stored message was received is notified of the first user message.

18. The article of manufacturing of claim 15, wherein said first user message is received by e: mail, SMS or speech.

19. The article of manufacturing of claim 15, wherein said first user message is received by speech.

20. The article of manufacturing of claim 15, wherein said step of querying said message database comprises identifying keywords in said first user message and querying said message database for previously stored messages containing said keywords, or words related thereto.
